(19) United States
(12) Patent Application Publication
(10) Pub. No.: US 2012/0114029 A1
(43) Pub. Date: May 10, 2012

(54) METHOD AND APPARATUS FOR MEASURING TIME DELAY IN ENVELOPE ELIMINATION AND RESTORATION TRANSMITTER

(75) Inventors: Joon-gyu RYU, Daejeon-si (KR); Deock-Gil OH, Daejeon (KR); Sang-Gee KANG, Daejeon-si (KR)

(73) Assignee: Electronics and Telecommunications Research Institute, Daejeon (KR)

(21) Appl. No.: 13/290,556

(22) Filed: Nov. 7, 2011

(30) Foreign Application Priority Data
Nov. 8, 2010 (KR) 10-2010-0110461

(51) Int. Cl. H04B 17/00

(52) U.S. Cl. 375/224

(57) ABSTRACT

Provided are a method and apparatus for measuring a time delay in an envelope elimination and restoration (EER) transmitter. A method of measuring a time delay in an EER transmitter includes receiving a modulated sinusoidal signal and distributing the modulated sinusoidal signal to be transmitted through transmission lines separated from each other, extracting an amplitude modulation signal and a phase modulation signal from the modulated sinusoidal signal, and detecting envelops of the amplitude and phase modulation signals and determining a difference in time between the amplitude and phase modulation signals. In the EER transmitter, to measure a time delay between input and output signals, time delays of paths of amplitude and phase modulation signals of the input signal are compared, thereby determining a difference in time between the amplitude and phase modulation signals.

### CROSS-REFERENCE TO RELATED APPLICATION

This application claims the benefit under 35 U.S.C. §119(a) of Korean Patent Application No. 10-2010-0110461, filed on Nov. 8, 2010, the disclosure of which is incorporated by reference in its entirety for all purposes.

### BACKGROUND

1. Field

The following description relates to a method and apparatus for measuring a time delay in an envelope elimination and restoration (EER) transmitter, and more particularly, to a method and apparatus for measuring a time delay between an amplitude signal and a phase signal in an EER transmitter.

2. Description of the Related Art

Many studies have recently been conducted to provide various services in multiple bands and multiple modes without changing hardware of a wireless communication terminal. In particular, a transmitter of the wireless communication terminal should consider not only its operational frequency range but also its energy efficiency and linearity between its input and output. Transmitters of wireless terminals include a polar modulation transmitter and an EER transmitter.

The polar modulation transmitter is a transmitter that operates in multiple bands and multiple modes and has high efficiency. However, since the polar modulation transmitter performs baseband signal processing and analog signal processing in direct connection with each other, it is difficult to implement a high-efficiency transmitter that operates in a radio frequency (RF) or intermediate frequency (IF) band.

Meanwhile, a conventional EER transmitter receives a sinusoidal signal and distributes the received sinusoidal signal to an envelope detector and a limiter through a power distributor. An amplitude modulation signal from the envelope detector and a phase modulation signal from the limiter are combined in a power amplifier. However, if a time delay of a path from the envelope detector to the power amplifier does not agree with that of a path from the limiter to the power amplifier, the combined signal is distorted.

### SUMMARY

Exemplary embodiments provide a technology for measuring a time delay between input and output signals in an envelope elimination and restoration (EER) transmitter by comparing and measuring time delays of paths of amplitude and phase signals of an input signal.

In one general aspect, there is provided a method of measuring a delay time in an envelope elimination and restoration (EER) transmitter, the method including: receiving a modulated sinusoidal signal and distributing the modulated sinusoidal signal to be transmitted through transmission lines separated from each other; extracting an amplitude modulation signal and a phase modulation signal from the modulated sinusoidal signal; and detecting envelops of the amplitude and phase modulation signals and determining a difference in time between the amplitude and phase modulation signals.

In another general aspect, there is provided apparatus for measuring a time delay in an envelope elimination and restoration (EER) transmitter, the apparatus including: a first distributor configured to receive a modulated sinusoidal signal and distribute the modulated sinusoidal signal to be transmitted through transmission lines separated from each other; an extractor configured to extract an amplitude modulation signal and a phase modulation signal from the modulated sinusoidal signal; and a time-delay determiner configured to detect envelopes of the amplitude and phase modulation signals and determine a difference in time between the amplitude and phase modulation signals.

In the EER transmitter, to measure a time delay between input and output signals, time delays of paths of amplitude and phase modulation signals of the input signal are compared, thereby determining a difference in time between the amplitude and phase modulation signals. Also, a delay line is added to a transmission line based on the measured time mismatch, thereby correcting the time mismatch.

Other objects, features and advantages will be apparent from the following description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain aspects of the invention.

FIG. 1 is a flowchart illustrating a method of measuring a time delay according to an exemplary embodiment of the present invention;

FIG. 2A illustrates a pulse-modulated signal according to an exemplary embodiment of the present invention;

FIG. 2B illustrates an envelope-detected signal according to an exemplary embodiment of the present invention;

FIG. 3 is a block diagram illustrating a configuration of an apparatus for measuring a time delay according to an exemplary embodiment of the present invention;

FIG. 4A illustrates a time-delay output when no time delay exists according to an exemplary embodiment of the present invention;

FIG. 4B illustrates a time-delay output when a time delay exists according to an exemplary embodiment of the present invention;

FIG. 5A is a block diagram illustrating an apparatus for measuring a time delay to which a first delay line is added according to an exemplary embodiment of the present invention; and

FIG. 5B is a block diagram illustrating an apparatus for measuring a time delay to which a second delay line is added according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

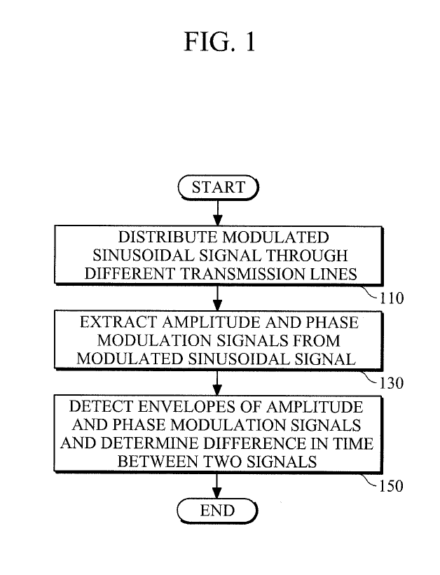

FIG. 1 is a flowchart illustrating a method of measuring a time delay according to an exemplary embodiment of the present invention.

Referring to FIG. 1, to measure a time delay in an envelope elimination and restoration (EER) transmitter, a pulse-modulated signal is first distributed through different transmission lines (110). The modulated sinusoidal signal has a radio frequency (RF) or intermediate frequency (IF). A sinusoidal signal is input in a pulse-modulated state. The modulated sinusoidal signal has amplitude and phase components.

The modulated sinusoidal signal is distributed through transmission lines separated from each other. In this case, a sinusoidal signal modulated under the same condition is distributed through each of the transmission lines. The modulated sinusoidal signal is distributed through the transmission lines separated from each other so as to be separated into an amplitude modulation signal and a phase modulation signal later. The lengths of the transmission lines may be set different from each other. Coaxial cables may be used as the transmission lines.

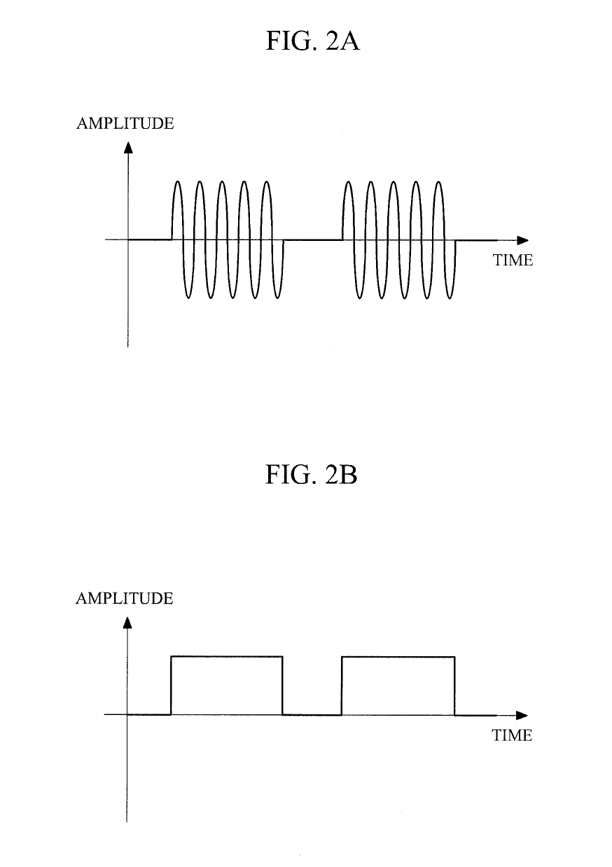

Subsequently, an amplitude modulation signal and a phase modulation signal are extracted from the modulated sinusoidal signal (130). As mentioned above, the modulated sinusoidal signal is distributed through the transmission lines separated from each other. The amplitude component of the modulated sinusoidal signal transmitted through one of the transmission lines is extracted through envelope detection. The envelope detection is to generate an envelope signal by connecting rising edges of an input signal. The envelope detection is one of demodulation methods to change a modulation signal into an original signal. In particular, the envelope detection is used to obtain phase information in analog modulation. The envelope detection will be described in detail with reference to FIGS. 2A and 2B.

FIG. 2A illustrates a pulse-modulated signal according to an exemplary embodiment of the present invention, and FIG. 2B illustrates an envelope-detected signal according to an exemplary embodiment of the present invention.

Referring to FIGS. 2A and 2B, a modulated sinusoidal signal is shown in FIG. 2A. Pulse modulation is to modulate a periodic pulse using a voice signal or other signal waves. The pulse modulation includes analog pulse modulation and digital pulse modulation. The analog pulse modulation is continuous level modulation in which the amplitude, width, position, etc. of a pulse is continuously changed. The digital pulse modulation is discontinuous level modulation in which the number or positions of unit pulses are changed depending on the amplitude of a signal wave. A sinusoidal signal modulated by the analog pulse modulation is shown in FIG. 2A.

The signal obtained by connecting rising edges of a modulated sinusoidal signal is an envelope signal. The envelope signal has a positive value. An envelope signal obtained by envelope-detecting the modulated sinusoidal signal of FIG. 2A is shown in FIG. 2B. Thus, the amplitude component of the modulated sinusoidal signal can be obtained through the envelope signal.

Meanwhile, phase information can be obtained by removing signals with a predetermined amplitude or more from the modulated sinusoidal signal transmitted through the other of the transmission lines. If the signals with the predetermined amplitude or more are removed from the modulated sinusoidal signal, a signal with an equivalent envelope is obtained. Phase information can be extracted through the signal with the equivalent envelope. As described above, the amplitude modulation signal and the phase modulation signal are extracted by distributing the modulated sinusoidal signal through the transmission lines separated from each other, envelope-detecting one of the distributed signals and limiting the other of the distributed signals to a predetermined signal level.

The method according to an exemplary embodiment further includes combining the amplitude modulation signal and the phase modulation signal and amplifying the combined signal. The EER transmitter amplifies an input signal and transmits the amplified signal. Thus, the amplitude modulation signal and the phase modulation signal of the modulated sinusoidal signal are combined, and the combined signal is amplified and transmitted to a destination.

Referring back to FIG. 1, envelopes of the amplitude and phase modulation signals are detected, and a difference in time between the amplitude and phase modulation signals is determined (150). The amplitude modulation signal and the phase modulation signal are envelope-detected through different transmission lines, respectively. The presence of a time delay is determined by comparing the envelope signals extracted through the envelope detection. In this case, the presence of the time delay can be determined by subtracting one of the envelope signals of the amplitude and phase modulation signals from the other envelope signal.

The reason that the time delay occurs is that there is a difference between paths along which the amplitude and phase modulation signals are transmitted, respectively. In satellite communication, an original signal is restored by combining amplitude and phase modulation signals of an input signal, and the restored signal is transmitted. In this case, since the amplitude and phase modulation signals are transmitted through transmission lines separated from each other and then combined, a time delay occurs due to the difference between lengths of the transmission lines.

Meanwhile, the method according to an exemplary embodiment further includes amplifying a time-difference signal obtained from the amplitude and phase modulation signals. In other words, a time-delay signal is generated by subtracting the amplitude modulation signal from phase modulation signals or vice versa, and the generated time-delay signal is amplified. The amplification is performed for a designer to easily measure a time delay between input and output signals when manufacturing a transmitter. Due to the amplification, the designer can determine whether or not a time delay occurs between input and output signals in a transmitter used in the satellite communication.

The method according to an exemplary embodiment further includes redistributing the amplitude and phase modulation signals. An EER transmitter basically combines amplitude and phase modulation signals, amplifies the combined signal and then transmits the amplified signal. However, an EER transmitter according to an exemplary embodiment distributes the amplitude and phase modulation signals and then analyzes a difference in time between the amplitude and phase modulation signals. Thus, by distributing the amplitude and phase modulation signals, it is possible to determine the presence of a time delay before the modulated sinusoidal signal is transmitted.

In a method according to an exemplary embodiment, the modulated sinusoidal signal is transmitted through a transmission line to which a delay line is added. In this case, the delay line is additionally connected to one of the transmission lines separated from each other. The delay line is added to match the amplitude and phase modulation signals when a difference in time occurs between the amplitude and phase modulation signals. This is because the original signal is distorted when the amplitude and phase modulation signals having the difference in time are combined. Thus, a signal having a shorter transmission time among the amplitude and phase modulation signals is determined, and the delay line is added to the transmission line through which the signal is transmitted.

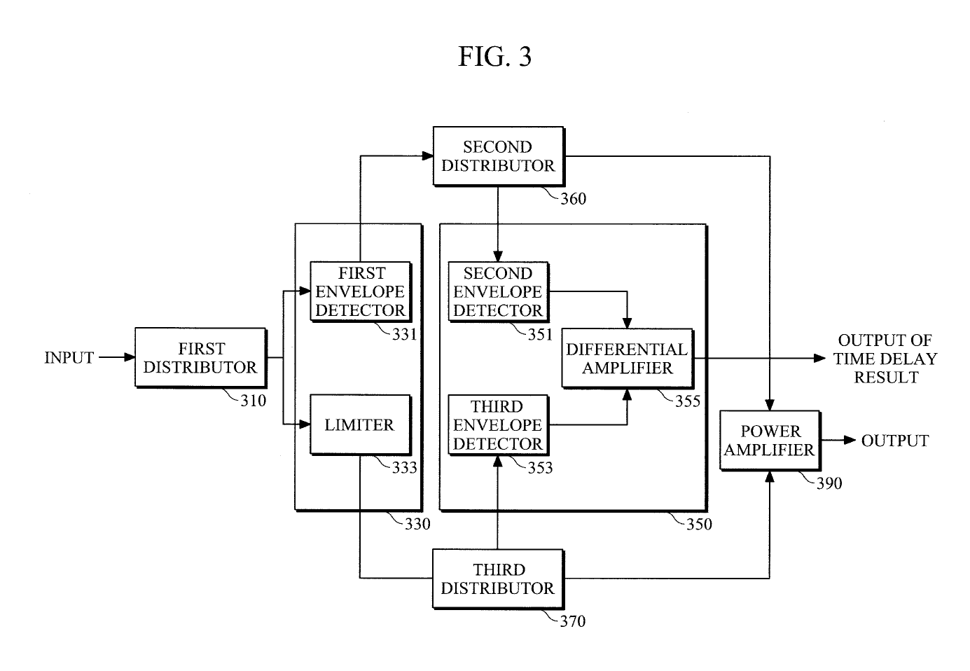

FIG. 3 is a block diagram illustrating a configuration of an apparatus for measuring a time delay according to an exemplary embodiment of the present invention.

Referring to FIG. 3, the apparatus includes a first distributor 310, an extractor 330, a time-delay determiner 350, a power amplifier 390, a second distributor 360 and a third distributor 370. The first, second and third distributors 310, 360 and 370 are couplers or dividers. The first distributor 310 receives a modulated sinusoidal signal and outputs the modulated sinusoidal signal to the extractor 330. The first distributor 310 and the extractor 330 are connected using a transmission line. The connection between the first distributor 310 and the extractor 330 is made by transmission lines separated from each other.

The extractor 330 includes a first envelope detector 331 and a limiter 333. The extractor 330 receives the modulated sinusoidal signal distributed by the first distributor 310 through the transmission lines. The first envelope detector 331 of the extractor 330 includes a diode and a low-frequency filter. The first envelope detector 331 detects an envelope signal by detecting rising edges of the waveform of the modulated sinusoidal signal. The envelope signal detected by the first envelope detector 331 is an amplitude modulation signal of the modulated sinusoidal signal. The first envelope detector 331 outputs the detected envelope signal to the second distributor 360 through a transmission line.

The limiter 333 of the extractor 330 includes a diode and a filter, which limit the amplitude of an input signal to a predetermined level. The limiter 333 receives the modulated sinusoidal signal from the first distributor 310 through a transmission line separated from the transmission line connecting the first distributor 310 and the first envelope detector 331. The limiter 333 outputs a signal with an equivalent envelope by removing signals having an amplitude level or more, which is set by a user. Thus, the limiter 333 outputs a phase modulation signal of the modulated sinusoidal signal. The limiter 333 outputs the phase modulation signal to the third distributor 370 connected thereto through a transmission line.

The second distributor 360 is a coupler or divider as mentioned above. The second distributor 360 receives an amplitude modulation signal from the first envelope detector 331 of the extractor 330 through a transmission line. The second distributor 360 distributes the received amplitude modulation signal to a second envelope detector 351 of the time-delay determiner 350 and the power amplifier 390. Thus, the apparatus according to this exemplary embodiment combines the amplitude and phase modulation signals, amplifies the combined signal, and measures time delays of the amplitude and phase modulation signals.

The third distributor 370 is a coupler or divider as mentioned above. The third distributor 370 receives the phase modulation signal from the limiter 333 of the extractor 330 through the transmission line separated from the transmission line connected to the second distributor 360. The third distributor 370 distributes the received phase modulation signal to a third envelope detector 353 of the time-delay determiner 350 and the power amplifier 390. Thus, the apparatus according to this exemplary embodiment combines the amplitude and phase modulation signals, amplifies the combined signal, and measures time delays of the amplitude and phase modulation signals.

The time-delay determiner 350 analyzes a difference in time between the amplitude and phase modulation signals. The time-delay determiner 350 includes the second envelope detector 351, the third envelope detector 353 and a differential amplifier 355. The second envelope detector 351 of the time-delay determiner 350 receives an amplitude modulation signal of the modulated sinusoidal signal from the second distributor 360. The second envelope detector 351 envelope-detects the received amplitude modulation signal and outputs the envelope detection signal to the differential amplifier 355. The third envelope detector 353 of the time-delay determiner 350 receives the phase modulation signal of the modulated sinusoidal signal from the third distributor 370. The third envelope detector 353 envelope-detects the received phase modulation signal and outputs the envelope detection signal to the differential amplifier 355.

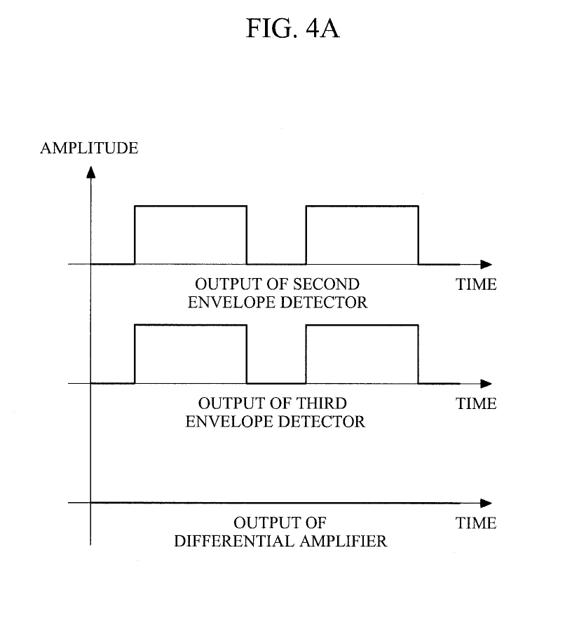

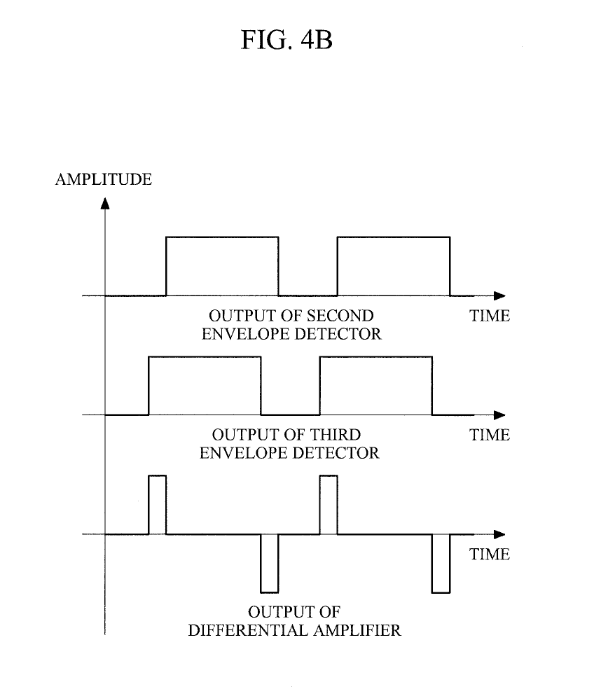

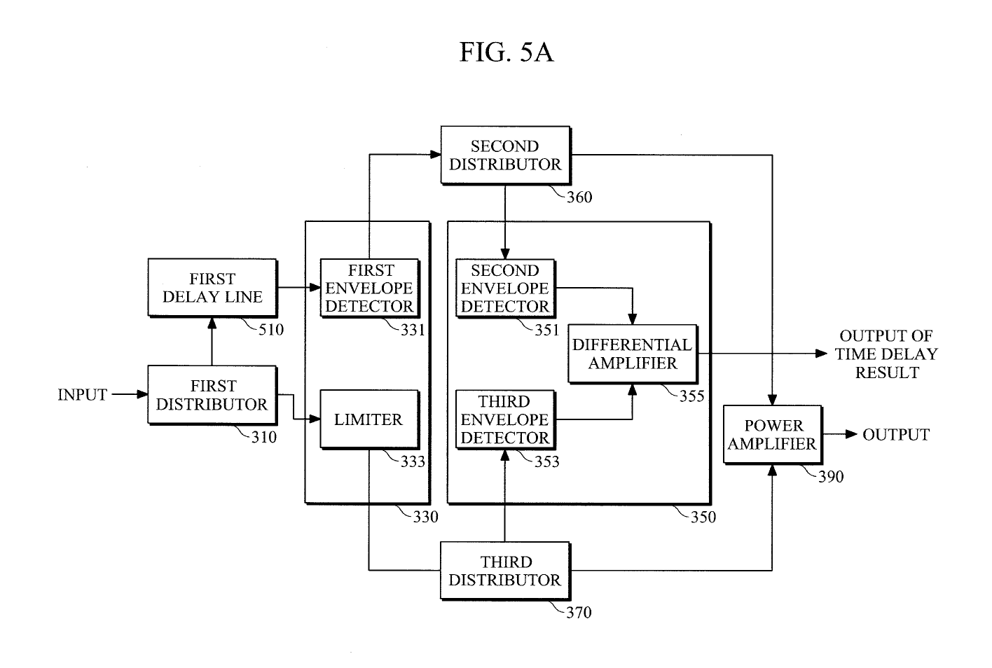

The differential amplifier 355 subtracts one input from another input and amplifies a subtraction result signal. The differential amplifier 355 receives the envelope detection signal of the amplitude modulation signal from the second envelope detector 351, and receives the envelope detection signal of the phase modulation signal from the third envelope detector 353. The envelope detection signal of the amplitude modulation signal, the envelope detection signal of the phase modulation signal and the subtraction result signal will be described in detail with reference to FIGS. 4A and 4B.

FIG. 4A illustrates a time-delay output when no time delay exists according to an exemplary embodiment of the present invention, and FIG. 4B illustrates a time-delay output when a time delay exists according to an exemplary embodiment of the present invention.

Referring to FIG. 4A, no time delay occurs between an envelope detection signal of an amplitude modulation signal input from the second envelope detector 351 and an envelope detection signal of a phase modulation signal input from the third envelope detector 353. In other words, no time delay occurs on the transmission line connecting the first distributor 310 to the first envelope detector 331 and the transmission line connecting the first envelope detector 331 to the second distributor 360. Also, no time delay occurs on the transmission line connecting the first distributor 310 to the limiter 333 and the transmission line connecting the limiter 333 to the third distributor 370. Thus, if a subtraction result signal obtained by subtracting one of the two signals from the other signal has a value of zero, no time delay occurs between the two signals.

Referring to FIG. 4B, a time delay occurs between an envelope detection signal of an amplitude modulation signal input from the second envelope detector 351 and an envelope detection signal of a phase modulation signal input from the third envelope detector 353. In other words, the envelope detection signal of the phase modulation signal input from the third envelope detector 353 has a shorter transmission time than the envelope detection signal of the amplitude modulation signal input from the second envelope detector 351.

Thus, a signal obtained by subtracting one of the two signals from the other signal and then amplifying the subtraction result signal does not have a result value of zero. In this case, it can be seen that the time delay occurs on the transmission line through which the envelope detection signal of the amplitude modulation signal is transmitted. The time-delay determiner 350 outputs an output of the differential amplifier 355 to an external apparatus such as an oscilloscope. The oscilloscope is an apparatus that outputs a change in input voltage with respect to time on a screen. Accordingly, the designer can determine the presence of a time delay while viewing a differential signal between amplitude and phase modulation signals of a designed transmitter.

Referring back to FIG. 3, the power amplifier 390 is configured as an operational-amplifier (op-amp) that combines two inputs and amplifies the combined signal. The power amplifier 390 receives an amplitude modulation signal from the second distributor 360, and a phase modulation signal from the third distributor 370. A transmission signal is completed by combining the received amplitude and phase modulation signals. The transmission signal includes both of amplitude information and phase information. The power amplifier 390 amplifies the combined signal and transmits the amplified signal to the outside.

As described above, the apparatus for measuring a time delay according to an exemplary embodiment is a transmitter used in satellite communication, for example, a block upconverter (BUC). The BUC is used in uplink transmission of a satellite signal. The BUC converts a frequency band from low frequency to RF. Current BUCs convert a frequency band from L-band to Ku-band, C-band or Ka-band. Most BUCs use a phase-locked loop (PLL) local oscillator, and use an external 10-Mhz local oscillator to maintain a normal transmission frequency.

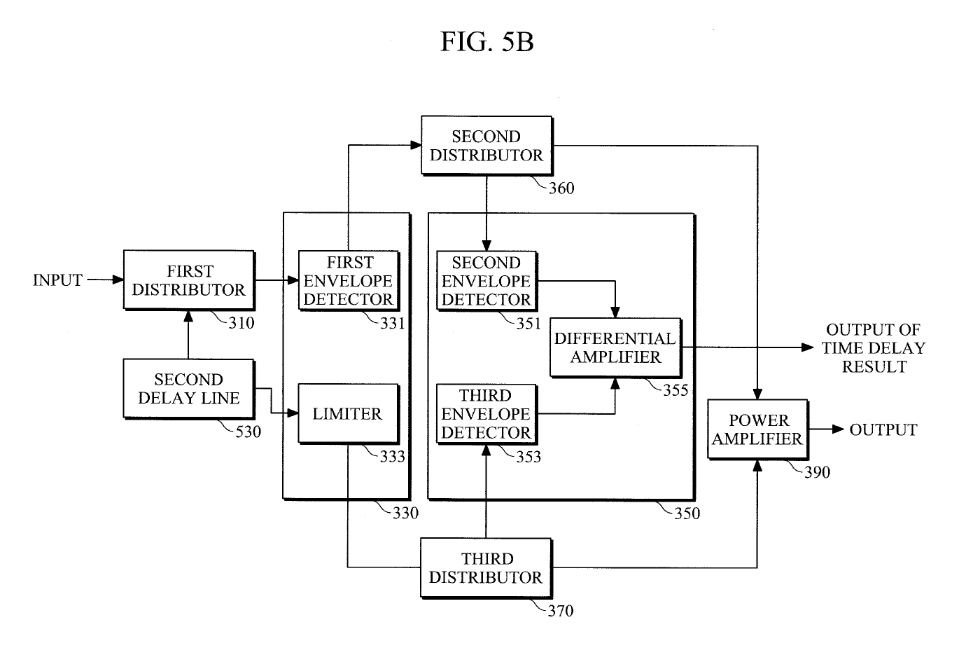

FIG. 5A is a block diagram illustrating an apparatus for measuring a time delay to which a first delay line is added according to an exemplary embodiment of the present invention. FIG. 5B is a block diagram illustrating an apparatus for measuring a time delay to which a second delay line is added according to an exemplary embodiment of the present invention.

Referring to FIG. 5A, a first delay line is added to the transmission line connecting the first distributor 310 and the first envelope detector 331 of the extractor 330 in the apparatus of FIG. 3. The first delay line is a coaxial cable. The designer of a transmitter determines the presence of a time delay between amplitude and phase modulation signals by determining an output of the differential amplifier 355. If it is determined that a time delay exists, and the transfer time of the amplitude modulation signal is shorter than that of the phase modulation signal, the first delay line is added between the first distributor 310 and the first envelope detector 331 of the extractor 330. Thus, it is possible to solve time mismatch between amplitude and phase modulation signals in the manufacture of a transmitter for satellite communication.

Referring to FIG. 5B, a second delay line is added to the transmission line connecting the first distributor 310 and the limiter 333 of the extractor 330. The second delay line is a coaxial cable. The designer of a transmitter determines a time delay between amplitude and phase modulation signals by determining an output of the differential amplifier 355. If it is determined that a time delay exists, and the transfer time of the phase modulation signal is shorter than that of the amplitude modulation signal, the second delay line is added between the first distributor 310 and the limiter 333 of the extractor 330. Thus, it is possible to solve time mismatch between amplitude and phase modulation signals in the manufacture of a transmitter for satellite communication.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A method of measuring a delay time in an envelope elimination and restoration (EER) transmitter, comprising:
receiving a modulated sinusoidal signal and distributing the modulated sinusoidal signal to be transmitted through transmission lines separated from each other;
extracting an amplitude modulation signal and a phase modulation signal from the modulated sinusoidal signal; and
detecting envelops of the amplitude and phase modulation signals and determining a difference in time between the amplitude and phase modulation signals.

2. The method of claim 1, wherein the extracting of the amplitude and phase modulation signals includes detecting an envelope of the modulated sinusoidal signal to extract the amplitude modulation signal.

3. The method of claim 1, wherein the extracting of the amplitude and phase modulation signals includes removing signals with a predetermined amplitude or more from the modulated sinusoidal signal to extract the phase modulation signal.

4. The method of claim 1, wherein the determining of the difference in time includes:
detecting the envelops of the amplitude and phase modulation signals;
analyzing the difference in time between the amplitude and phase modulation signals of which the envelopes are detected; and
amplifying a time-difference signal between the amplitude and phase modulation signals.

5. The method of claim 4, further comprising combining the amplitude and phase modulation signals and amplifying the combined signal.

6. The method of claim 5, further comprising distributing the amplitude and phase modulation signals to the detecting of the envelopes and the combining the amplitude and phase modulation signals and amplifying the combined signal.

7. The method of claim 1, wherein the distributing of the modulated sinusoidal signal includes transmitting the modulated sinusoidal signal to a transmission line to which a delay line is added.

8. The method of claim 7, wherein the delay line is added to one of the transmission lines separated from each other.

9. The method of claim 1, wherein the modulated sinusoidal signal has a radio frequency (RF) or intermediate frequency.

10. An apparatus for measuring a time delay in an envelope elimination and restoration (EER) transmitter, comprising:
a first distributor configured to receive a modulated sinusoidal signal and distribute the modulated sinusoidal signal to be transmitted through transmission lines separated from each other;
an extractor configured to extract an amplitude modulation signal and a phase modulation signal from the modulated sinusoidal signal; and
a time-delay determiner configured to detect envelopes of the amplitude and phase modulation signals and determine a difference in time between the amplitude and phase modulation signals.

11. The apparatus of claim 10, wherein the extractor includes:
a first envelope detector configured to detect an envelope of the modulated sinusoidal signal to extract the amplitude modulation signal; and
a limiter configured to remove signals with a predetermined amplitude or more from the modulated sinusoidal signal to extract the phase modulation signal.

12. The apparatus of claim 10, wherein the time-delay determiner includes:
a second envelope detector configured to detect the envelope of the amplitude modulation signal;
a third envelope detector configured to detect the envelope of the phase modulation signal; and
a differential amplifier configured to analyze a difference in time between the amplitude and phase modulation signals of which the envelopes are detected and amplify the difference in time.

13. The apparatus of claim 12, further comprising a power amplifier configured to combine the amplitude and phase modulation signals and amplify the combined signal.

14. The apparatus of claim 13, further comprising a second distributor configured to distribute the amplitude modulation signal to the second envelope detector and the power amplifier.

15. The apparatus of claim 13, further comprising a third distributor configured to distribute the phase modulation signal to the third envelope detector and the power amplifier.

16. The apparatus of claim 11, further comprising a first delay line configured to delay the amplitude modulation signal and connected between the first distributor and the first envelope detector.

17. The apparatus of claim 11, further comprising a second delay line configured to delay the phase modulation signal and connected between the first distributor and the limiter.
